(19) United States
(12) Patent Application Publication
(10) Pub. No.: US 2004/0125075 A1
(43) Pub. Date: Jul. 1, 2004

(54) DVD remote control with interchangeable, title-specific interactive panels

(76) Inventor: Richard A. Diercks, Minneapolis, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/334,540

(22) Filed: Dec. 31, 2002

(51) Int. Cl. G09G 5/00

(52) U.S. Cl. 345/156

(57) ABSTRACT

A system for playing programs includes a monitor, a player and a remote control. The remote control has a base and set of interchangeable faceplates. Each faceplate is matched to a program so that the switches of the faceplate correspond to icons that represent menu selections of the program to provide a simple user interface.

### BACKGROUND OF THE INVENTION

I. Field of the Invention

The present invention relates to remote controls for DVD players. More specifically, the present invention relates to a universal DVD remote control that incorporates title-specific interchangeable faceplates. Such a remote control can be used with a DVD player to navigate through and use programs provided in DVD format.

II. Description of the Related Art

Historically, the recording and playback of sound and video has involved dumb media and smart machines. Vinyl records are simply mechanical grooves from which a phonograph could interpret and produce sound and music. Audio tapes are recorded using a recording head that magnetizes the tape in a pattern that is reflective of the sound to be recorded. During playback, the tape moves past a playback head. The magnetic fields from the magnetized region of the tape sweep past the playback head and cause fluctuating electric currents to flow through the head. The changing magnetic field produces an electric field in the head which is amplified and used to operate the speakers to produce the recorded sound. Thus, the magnetized regions of the tape provide the same function as the mechanical grooves of a phonograph record. Video tapes work in a similar fashion with recording heads to create magnetic patterns on the tape and playback heads to read those magnetic patterns.

Even in the digital age, compact discs are dumb. A recording device creates lands and pits representing ones and zeroes on the disc. The compact disc player then reads the lands and pits and processes them to play back sound and video. Whether it is a phonograph, an audio tape player, a video tape player or even a CD player, all of the logic and intelligence is located in the player rather than in the media used with the player.

Various systematic disadvantages arise from the approach of using dumb media and smart players. For example, it is almost impossible to change the way the user interacts with the media to any significant degree. Even with audio compact discs, the media is so limited that the only option really available to the user is to change the order in which the songs recorded on the media are played. The creator of content for media such as phonograph records, audio tapes, video tapes and even compact discs are severely restricted since they are only able to use functions of the player in only the prescribed manner in developing content.

Over the past 20 years, video cassette recorders, compact disc players, televisions, stereo receivers, audio tape players and the like have been sold with a user interface on the machine itself, as well as a remote control which provides a second user interface. Until very recently, each remote control was designed specifically for use with a particular type and model of device. More recently, remote control function has become more standardized. As such, universal and teachable remote controls are now offered for sale which interface with multiple consumer electronic hardware products in the home.

Digital versatile disc (DVD) represents a sea change. DVD players are smarter than their predecessors. More importantly, DVD media (the authored discs) are very smart. DVD video players support a wide range of digital formats and allow many avenues of access through a standardized set of commands. The authors of DVD media can take advantage of these capabilities to create a variety of products, all of which can be played on the DVD player. The remote control of the DVD player can be used to access the various features of the DVD media. Such access can be through numbers on the remote control's keypad, the remote control's arrows that move a cursor around a menu, or through the remote control's direct input keys. As such, a standard DVD remote control is the most complex consumer interface yet produced.

The DVD's specification universally adopted by most manufacturers assigns key functions to each key or button of the remote control However, a DVD disc can be authored to use that function or key in a completely different manner than that intended by the specification. For example, a DVD disc could be authored so that the viewer has to enter an entire numeric code to gain access to the disc or certain sections of the program. Also, the DVD disc can be authored to perform entirely different functions in response to signals created by the user pressing the direct input keys than those contemplated by the standard. Such capabilities represent opportunities heretofore unknown in the consumer electronic industry for media authors.

### SUMMARY OF THE INVENTION

The present invention takes advantage of the capabilities of DVD players and expands the usefulness of DVD media by providing a totally unique remote control having interchangeable faceplates, each of which is matched to one or more DVD disks. Specifically, icons on the faceplate are matched to icons in program menus displayed on television when the DVD disk is played in the DVD player. The viewer can press the matching icon on the remote control to navigate and use the program.

This invention has a variety of applications. First, the present invention can be used in international or multi-lingual environments. Internationally recognizable icons can be incorporated into the program and a matching faceplate for a remote control so that language barriers do not preclude one from using the program.

Second, the present invention has broad application for media designed for young children who can learn, but have not yet learned to read. Programs designed for them can include icons that match those on the faceplate. The icons can, for example, be cartoon characters, shapes, colors, numbers or letters. The program can be a learning tool that captures the child's attention and the remote control equipped with the title-specific faceplate can easily be used by the child to direct the program. The child does not become frustrated by the user interface because the matching icons of the program and the faceplate are geared to his or her level. Also, depending upon the program itself, the child receives constant feedback. Children's programs on DVD can be in the form of either entertainment or educational media.

Third, the present invention permits DVD media to be combined with books, such as children's books, to provide an interactive multimedia experience. For example, a book can be packaged with a DVD media capable of being played on any DVD player. Switches are built into the book beneath pictures or other icons printed on the pages of the book. Thus, the pages of the book become the faceplate of the remote control for the DVD player. As the switches are actuated, signals are sent to the DVD player which control the operation of the DVD player based upon software instructions coded on the DVD media.

Fourth, the present application has application as a low cost training aid. For example, the DVD player and television set, in conjunction with the program stored on the DVD media, can function as a simulator for any of a variety of pieces of equipment such as hazardous material disposal equipment, medical equipment, manufacturing equipment or the like. The faceplate for the remote control can be designed to match the controls for the piece of equipment, the operation of which is simulated by the program recorded on the DVD disc. A specific advantage provided by applicant's invention is that any of a variety of pieces of equipment can be the subject of the simulation using the same television, player and remote control. All the creator of the simulation needs to provide is the program on a DVD disk and a matching faceplate.

The type and number of applications of the present invention can be expanded further through use of the programmable memory registers of a standard DVD video player. Such players have sixteen 32 kilobyte programmable memory registers. These registers can be used for a variety of functions such as tracking scores in a DVD-based game, monitoring progress through a DVD-based lesson, or even tailoring the program recorded on the DVD based upon the ability level of a user.

A greater understanding of the present invention and the advantages it affords can be derived from the following detailed description of the invention in light of the drawings which form a part of this disclosure.

### BRIEF DESCRIPTION OF THE DRAWINGS

FIG. 1 is a schematic diagram showing the components of the present invention.

FIG. 2 is a block diagram of the remote control base unit of the present invention.

FIG. 3 is a block diagram of a remote control faceplate made in accordance with the present invention.

FIG. 4 is a perspective view of a first faceplate made in accordance with the present invention.

FIG. 5 is a perspective view of a second faceplate made in accordance with the present invention.

FIG. 6 is a diagram showing a faceplate for a numbers and counting game showing the pin configuration for each button of the faceplate.

FIG. 7 is a diagram showing the faceplate for another program showing the pin configuration for each button of the faceplate.

FIG. 8 is a diagram showing still another faceplate used with still a different program and the pin configuration for said faceplate.

FIG. 9 is a diagram of a book equipped so that the pages of the book serve as a remote control faceplate.

FIG. 10 is a diagram of the embodiment available as an alternative to FIG. 9 wherein all of the remote control circuitry is built into the book.

### DETAILED DESCRIPTION OF THE PREFERRED EMBODIMENT

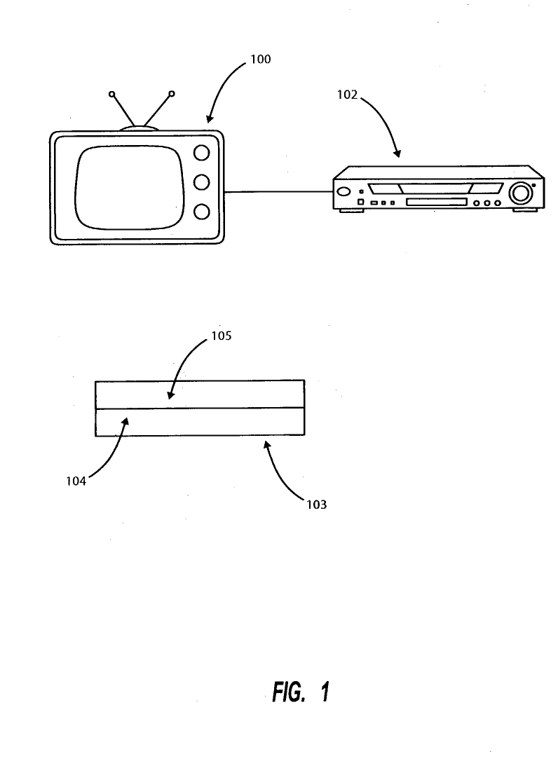

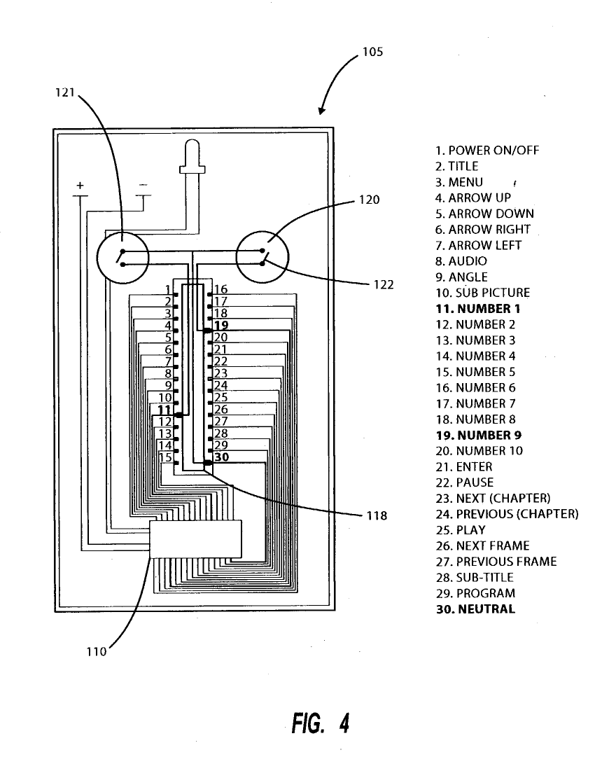

As shown in FIG. 1, programs taking advantage of the present invention are played using a television 100 which is connected to a standard DVD player 102. Programs stored on a DVD are inserted into the DVD player 102. To navigate through the program, a remote control 103 is provided. The remote control 103 includes a base unit 104 and at least one interchangeable, title-specific interactive faceplate 105 having a set of switches labeled with icons that correspond to icons displayed by the program on the television 100 when the program is played on the DVD player 102. As indicated, the interactive faceplates 105 are interchangeable. FIGS. 4-8 show some examples of the many interchangeable faceplates 105 that can be coupled to the base unit 104 to control the programs associated with the faceplates 105.

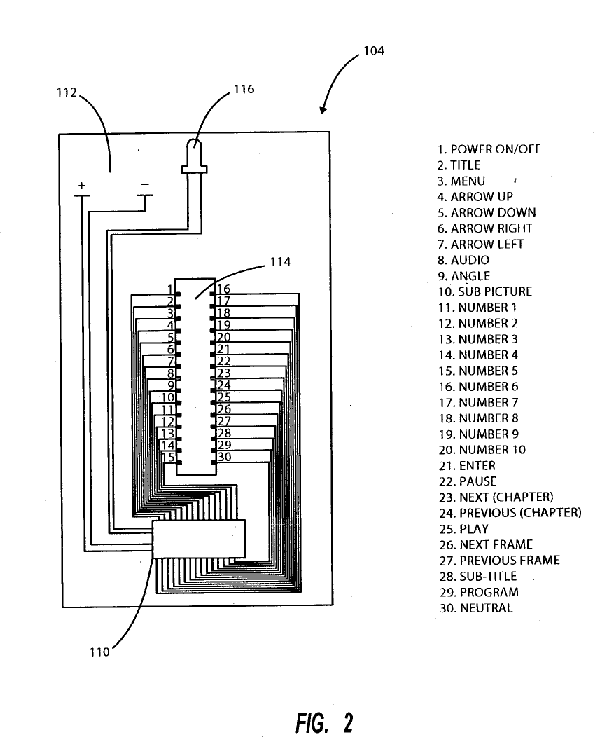

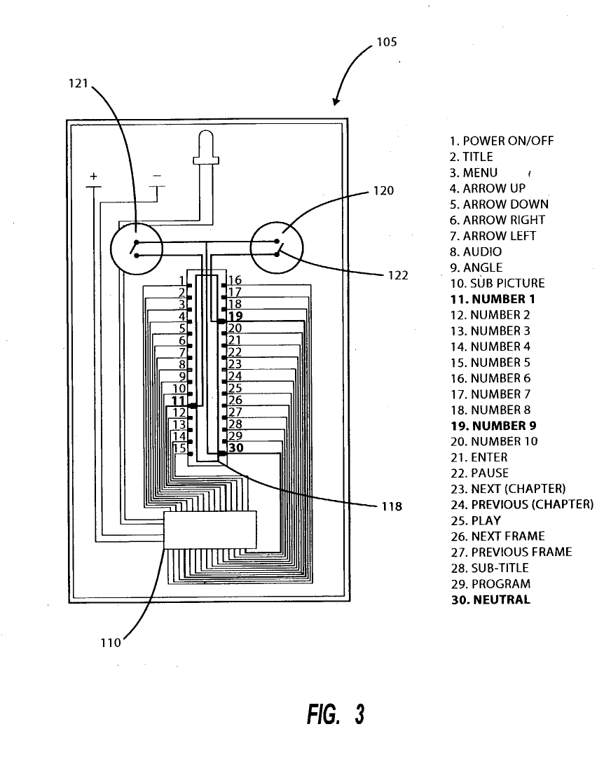

As indicated above, the remote control 103 of the present invention consists of two major separate components—a base unit 104 and at least one interchangeable faceplate 105. The construction of the base unit 104 is shown in FIG. 2. The basic construction of a remote control faceplate 105 is shown in FIG. 3.

As shown in FIG. 2, the base unit 104 has a control chip 110. This is a standard control chip commonly used in any universal or DVD specific remote control. Supplying power to the remote control 103 is a battery 112. The control chip 110 also includes a female connector 114. Thirty different electrical paths 1-30 are provided from the connector 114 to the control chip 110. Finally, the base unit includes a transmitter, typically an IR lamp 116 which is illuminated by the control chip 110 to send command signals to the DVD player 102.

Control chips for DVD remotes include certain standard pins. These pins are used to create the electrical paths 1-30 from the female connector 114 to the control chip 110. The signals received by the control chip 110 via each of the pins are intended to cause the control chip 110 to send specific signals to the player 102 via the IR lamp 116. The design of the female connector 114 of the present invention is such that it can be quickly and easily mated with a male connector 118 of any of a number of interchangeable, title-specific faceplates 105. In addition to the male connector 118, the faceplates 105 each have at least one switch 120. Each switch is colored, labeled or shaped to correspond to the icons displayed by the program with which the particular faceplate 105 is associated. Each switch 120 is wired to the male connector 118 such that when the switch is actuated, a signal indicative of the switch actuation can be processed by the controller chip 110. In response to this signal, the controller chip 110 causes the IR lamp 116 to illuminate in a given pattern to send a message indicative of the specific switch closure to a receiver in the player 102.

The various switches 120 of the faceplate 105 are each electrically connected to the male connector 118 in such a way that when the male connector 118 and female connector 114 are connected and a switch is actuated, the control chip 110 knows which switch 120 has been actuated. The control chip 110 responds to the closure of different switches 120 by causing the IR lamp 116 to send a different signal to the player 102.

In FIG. 3, the faceplate 105 has two switches 121 and 122. Switches 121 and 122 are both wired to the male connector 118 such that when it is connected to the female connector 114, the control chip 110 knows when a switch is actuated and which switch is actuated. As FIG. 3 suggests, actuation of switch 121 causes the control chip 110 to receive a current through pin 11. Likewise, when switch 122 is actuated, the control chip 110 receives a current through pin 19. Switch 121 is also connected to another pin of the male connector 118. In response to receipt of a current via a particular pin, the control chip 110 causes the remote control 103 to send a signal to the player 102. Specifically, the control chip 110 illuminates the IR lamp 116 such that the IR lamp 116 sends a signal indicative of the “number 1” button of a standard remote control being depressed when switch 121 is depressed. This is true irrespective of the specific icon shape of the switch or the specific icon with which the switch is labeled. Likewise, when switch 122 is depressed, the remote control 103 sends a signal indicative of the “number 9” button of a standard remote control being depressed. How the program playing on the player 102 responds to receipt of these signals depends upon its design. Also, all of this is transparent to the user.

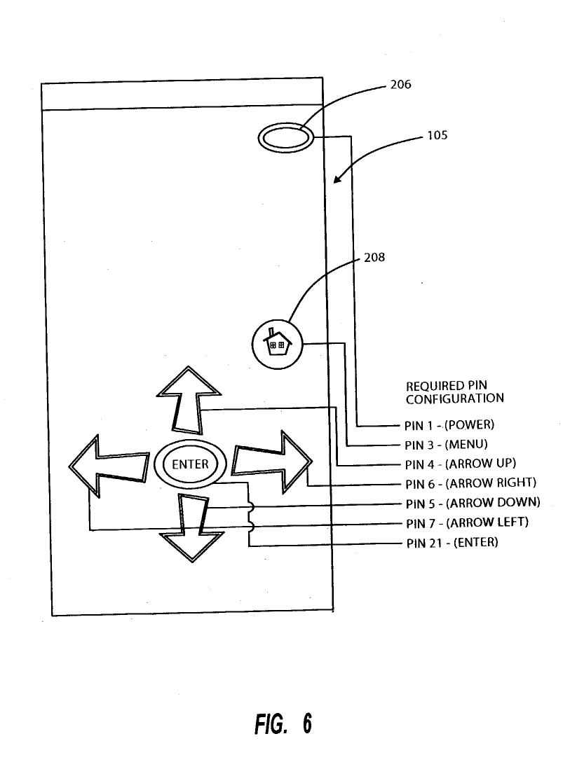

The advantages of the present invention from a user standpoint may be better understood with reference to FIGS. 6-8. In FIG. 6, the user interface is simplified by providing a faceplate that only includes eleven switches rather than the total of twenty-nine present on most standard DVD remotes. The faceplate shown in FIG. 6 is suitable for use with counting games. The faceplate includes a power button 206 coupled via the male connector 118 and female connector 114 to pin 1 and pin 30 of the control chip 110. The faceplate includes a menu button 208 coupled by connectors 118 and 114 to pin 3 and pin 30 of the control chip 110. The faceplate also includes nine number buttons, each of which are coupled by connectors to the neutral pin 30 and another appropriate pin of the control chip 110. When the male connector 118 is coupled to the female connector 114 and any of the switch buttons is actuated, control chip 110 senses the switch closure and causes the IR lamp 116 to send the appropriate signal to the player 102.

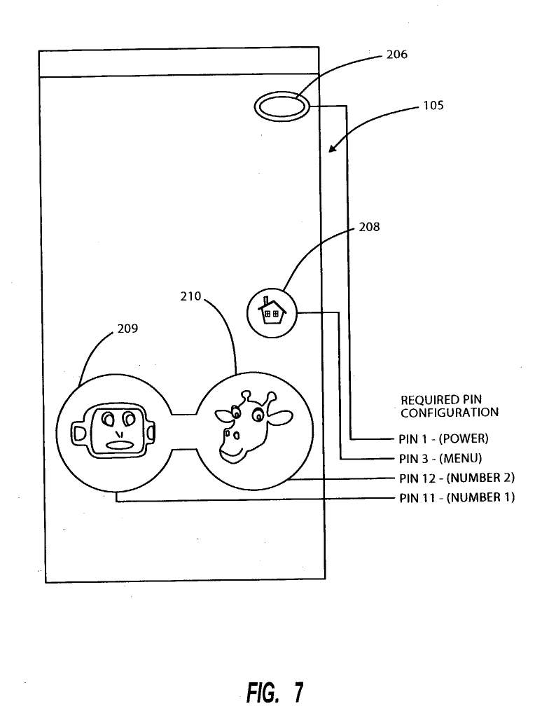

FIG. 7 shows another faceplate that provides even a simpler interface. It includes only seven switch buttons, each of which are electrically connected to the neutral pin 30 of the control chip 110 via the male connector 118 and the female connector 114. Each switch is also connected to an appropriate second pin of the control chip 110 for that switch via the connectors 114 and 118. When the faceplate shown in FIG. 7 and base 104 are attached together via the male connector 118 and female connector 114, depression of any of the switch buttons on the faceplate causes the control chip 110 and, thus the IR lamp 116, to send a corresponding signal to the player 102.

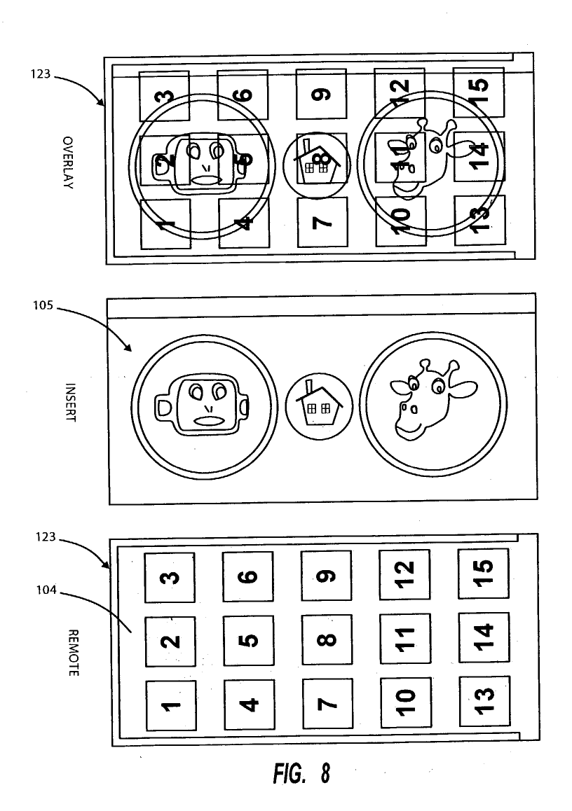

FIGS. 6 and 7 show faceplates that simplify the user interface by reducing the number of switch buttons and making the remaining switch buttons larger and more attractive and easier to manipulate. FIG. 8 (like FIG. 3) shows faceplate having a completely different set of switch buttons than that contemplated by the standards used to create standard remote controls and players. FIG. 8 has only four switch buttons—a power button 206, a menu button 208, a monkey button 209 and a giraffe button 210. The power and menu buttons are wired to create connections to the power and menu pins of the control chip 110 respectively when the male connector 118 and female connector 114 are joined together. Both are also wired to create a connection to the neutral pin of the control chip 110 as well. When the faceplate shown in FIG. 8 is connected to the base unit 104 such that the male connector 118 of the faceplate and the female connector 114 of the base 104 are electrically coupled together, actuation of the monkey button 209 causes the remote control 103 to generate a signal indicative of the “number 1” of a standard remote control. Pressing the giraffe button 210 sends a signal indicative of the “number 2” of a standard remote control. The player 102 processes these “number 1” and “number 2” signals based upon the program being played. In a well designed children's game, the giraffe and monkey buttons on the faceplate will match the icons displayed by the game on the television 101 to which the player 102 is attached.

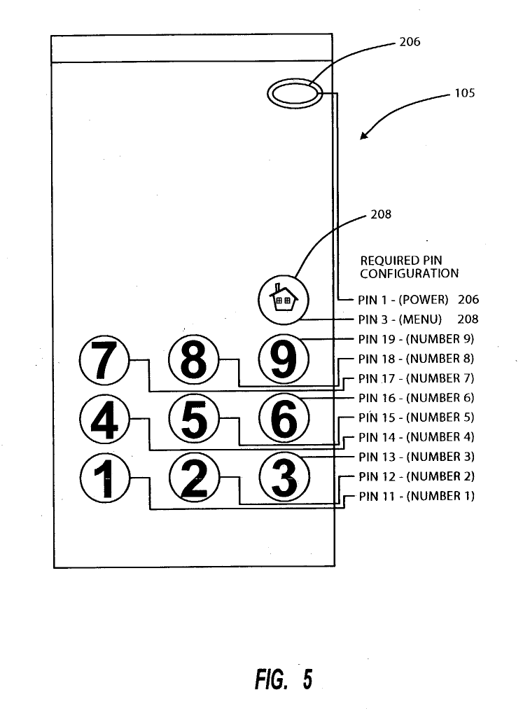

FIGS. 4 and 5 show other faceplates having buttons of different shapes and colors that can be wired to a male connector 118 in a predefined manner so the controller can send the desired standard signal to the DVD player upon actuation of each button.

From the foregoing, it should be clear that the faceplate 5 can include one to twenty-nine switch buttons. More, of course, can be added if a control chip other than a standard DVD chip is used in the remote and if the player can respond to a larger number of different signals. The switch buttons can be any shape, color or size. The switch buttons can be labeled with text or other symbols. What is important is that the switch buttons match (or at least correspond to) icons displayed on the television 1 or monitor attached to DVD player 2. The user simply presses the switch button that matches an icon on the screen with a menu selection from a menu of options shown on the screen to signal the program. The icons can be any shape, color, size, character, number, letter, symbol or group thereof. The present invention is highly useful in creating a simple user interface such that selection options shown on the screen of the television or other type of monitor match the switch buttons on the remote control.

A key to the present invention is the connection between the male connector of the faceplate with the female connector of the base. This can be accomplished in any of a variety of ways. The base unit and faceplate can be designed to snap together. These components can be built to incorporate interlocking rails or grooves. Even fabric hook and loop-type fasteners could be used. An extension cable can be used to electrically connect the male and female connectors, particularly if the user wants to be able to manipulate the switches from a position out of a direct line of sight from the DVD player 102. Such an extension cable permits the faceplate 105 and the base unit 104 to function together even if the faceplate 105 is positioned remotely from the base unit 104.

Further, while specific connectors are shown in the drawings, other connectors would be used. Also, reversing the connectors so the male connector is on the base and the female connector is on the faceplate is well within the scope of this invention. Whatever connectors and arrangement of connectors are used, there must be an output on the faceplate coupled to an input on the base unit such that the depression of any switch on the faceplate will cause the remote control 103 to issue a predetermined command to the player 102.

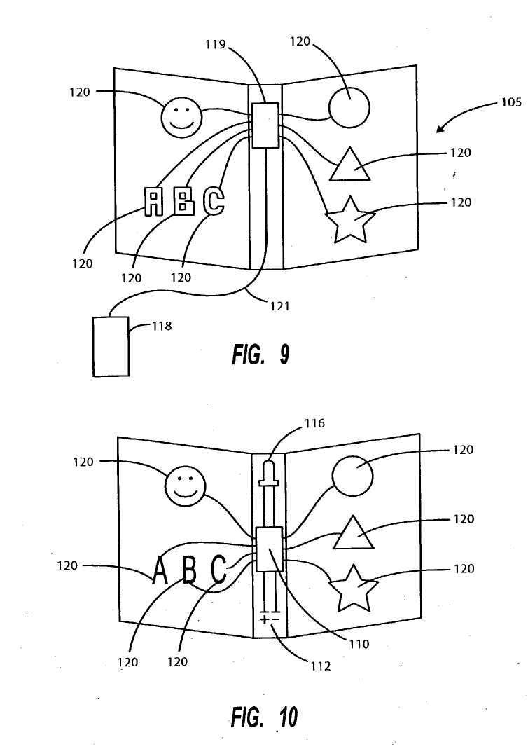

FIGS. 9 and 10 are representative of a highly advantageous application of the present invention. In FIG. 9, the faceplate 105 is in the form of a book. Located beneath various icons printed on the pages of the book are switches 120. Each switch is electrically coupled to the male connector 118 via a junction connector 119 located in the spine of the book and a cable 121 used to join the junction connector 119 to the male connector 118. These electrical connections are all made so that when the male connector 118 is joined to the female connector 114 of the base unit 104 shown in FIG. 2, the control chip 110 knows which switch 120 has been actuated. Thus, the control chip 110 can properly respond to the closure of any of the different switches 120 by causing the IR lamp 116 (see FIG. 2) to send the appropriate signal to the player 102 (see FIG. 1) to make the desired menu selection of the program stored on the DVD media.

The embodiment of FIG. 10 incorporates all of the remote control circuitry into the book itself. The switches are all directly wired to the control chip 110. The control chip 110 is powered by a battery 112. The control chip 110, upon actuation of a switch 120, causes the IR lamp 116 to send the appropriate signal to the player 102 (see FIG. 1) to make the desired menu selection of the program controlling the player.

Finally, the various faceplates shown in the drawings are just some examples of suitable faceplates. Virtually any arrangement, shape, size, color and labeling of the switch buttons can be used. The number of switches can range from one to twenty-nine or even higher. This is all dependent on the design of the program and creativity of the developer in developing a user interface that takes advantage of the present invention.

What is claimed:

1. A remote control for controlling the operation of a player capable of playing a plurality of programs, each program having menu selections and icons associated with said menu selections; said remote control comprising:
(a) a power source;
(b) a base having a control chip coupled to said power source, a transmitter controlled by said control chip, and a first electrical connector connected to said control chip; and
(c) at least one interchangeable faceplate having at least one switch corresponding to an icon associated with a menu selection of a program and a second electrical connector coupled to said at least one switch and said first electrical connector, wherein upon actuation of a switch of the faceplate the transmitter transmits a signal indicative of the actuation of said switch.

2. The remote control of claim 1 wherein said first connector and said second connector are coupled by a cable.

3. The remote control of claim 1 wherein said first connector and said second connector are coupled by a direct connection between said first connector and said second connector.

4. The remote control of claim 1 wherein said faceplate includes a plurality of switches, each electrically coupled to said second electrical connector.

5. The remote control of claim 4 wherein at least one of said switches is the same color as the icon with which it corresponds.

6. The remote control of claim 4 wherein at last one of said switches is the same shape as the icon with which it corresponds.

7. The remote control of claim 4 wherein at least one of said switches is labeled in a way that matches the icon with which it corresponds.

8. The remote control of claim 1 wherein the player controlled by said remote control is a DVD player.

9. A system for playing any of a plurality of different programs each having menu selections and icons associated with said menu selections, said system comprising:
(a) a monitor;
(b) a player attached to said monitor; and
(c) a remote control comprising (i) a power source; (ii) a base unit having a control chip coupled to said power source, a transmitter controlled by said control chip, and a first electrical connector connected to said control chip and (iii) at least one interchangeable faceplate having at least one switch corresponding to an icon associated with a menu selection of a program and a second electrical connector coupled to said at least one switch and said first electrical connector, wherein upon actuation of a switch of the faceplate the transmitter transmits a signal indicative of the actuation of said switch.

10. The system of claim 9 wherein said first connector and said second connector are coupled by a cable.

11. The system of claim 9 wherein said first connector and said second connector are coupled by a direct connection between said first connector and said second connector.

12. The system of claim 9 wherein said faceplate includes a plurality of switches, each electrically coupled to said second electrical connector.

13. The system of claim 12 wherein at least one of said switches is the same color as the icon with which it corresponds.

14. The system of claim 12 wherein at last one of said switches is the same shape as the icon with which it corresponds.

15. The system of claim 12 wherein at least one of said switches is labeled in a way that matches the icon with which it corresponds.

16. The system of claim 9 wherein the player controlled by said remote control is a DVD player.

17. The system of claim 9 wherein the monitor is a television.

18. A system for playing a program having menu selections and icons associated with the menu selections, said system comprising:
a. a monitor;
b. a player attached to said monitor; and
c. a remote control for the player in the form of a book comprising (i) a power source; (ii) a control chip coupled to the power source; (iii) a transmitter controlled by the control chip; and (iv) pages having icons printed thereon associated with a menu selection of a program, each of said icons associated with a switch whereupon actuation of a switch the transmitter sends a signal indicative of the actuation of the switch to the player.
